(19) United States
(12) Patent Application Publication
(10) Pub. No.: US 2018/0012206 A1
(43) Pub. Date: Jan. 11, 2018

(54) SYSTEM AND METHOD OF GIFT CARD REDEMPTION

(71) Applicant: Tellurium128 Limited, London (GB)

(72) Inventors: Saj Sood, Hampton (GB); David Maplesden, Brentwood (GB)

(21) Appl. No.: 15/639,482

(22) Filed: Jun. 30, 2017

Related U.S. Application Data
(60) Provisional application No. 62/358,360, filed on Jul. 5, 2016.

(51) Int. Cl. G06Q 20/10; G06Q 30/06; G06Q 20/38

(52) U.S. Cl. CPC G06Q 20/102; G06Q 20/382; G06Q 30/0613

(57) ABSTRACT

Systems and methods for online redemption of gift cards purchased through a secondary market comprises modifying a third-party application operating on a computing device to establish bi-directional communication between the third-party application and a gift card redemption application that operates on the computing device. Inject a code to the third party application to modify the visual presentation of the checkout page within the third party application to obscure gift card details when entered into the third party application to complete the transaction. Identify navigation to a checkout page within the third party application, and identify transaction completion within the third party application. Initiate recording of a transaction at the checkout page. Request payment through the gift card redemption application, access encrypted gift card details with the gift card redemption application. Monitor the third party application for completion of the transaction. Complete recording and store a record of the transaction.

### CROSS-REFERENCE TO RELATED APPLICATION

The present application claims priority of U.S. Provisional Patent Application No. 62/358,360, filed on Jul. 5, 2016, the content of which is hereby incorporated herein by reference in its entirety.

### BACKGROUND

The present disclosure is related to the field of gift card redemption. More specifically, the present disclosure relates to systems and methods for online redemption of gift cards purchased through a secondary market.

Gift cards may exist in physical or electronic form. Gift cards may go unused or may be inefficiently used when received as gifts. Secondary marketplaces exist for the sale and purchase of gift cards at prices less than their nominal value. This provides a discount from the nominal value to the purchaser while providing the seller with the purchasing flexibility of cash.

Gift cards purchased on secondary markets are at risk of fraud both by sellers and buyers. One reason for the risk of fraud is that the seller may keep the identifying gift card details after it has been sold on the secondary market. This leaves open the possibility that a seller is able to continue to use the gift card after agreeing to the sale, leaving the buyer with a depleted gift card balance when the buyer goes to use the purchased gift card. Buyers of gift cards from secondary markets may perpetrate fraud by using the purchased gift card and subsequently claiming that the balance on the gift card was not the balance as stated when the gift card was purchased on the secondary market. This may result in a credit card charge back to the seller and/or market place. In instances of fraud, it can be difficult to ascertain which party (the buyer or the seller) from the secondary market committed the fraud.

Current solutions to preventing the types of fraud as noted above include validating identities of both buyers and sellers, delaying payment to sellers to allow time for buyers to report discrepancies in the actual gift card balance, or attempting to charge sellers credit cards in cases where buyers report discrepancies. These efforts act merely as deterrents to committing fraud or, more particularly committing fraud more than once by the same individual by prohibiting that individual from participating further in a particular secondary market following a disputed sale or purchase. A need exists for better tools to prevent fraud by a new buyer or seller. Additionally, deterrents and or punitive efforts can be enhanced by improved collection of details regarding a transaction in order to identify and/or adjudicate instances of fraud.

### BRIEF DISCLOSURE

As described in further detail herein, embodiments of systems and methods as disclosed may provide additional encryption of the details of gift cards bought or sold in a secondary market and provide a redemption application through which the purchased gift cards are used to better control and document the use of such purchased gift cards.

Embodiments of the systems and methods are disclosed herein which automatically process the gift card details through the user's web browser presenting the merchant's website to complete the transaction with the purchased gift card. Details of the transaction are recorded to document the transaction in the event of a claim of fraud.

### BRIEF DESCRIPTION OF THE DRAWINGS

FIG. 1 is a schematic diagram which depicts an exemplary embodiment of software architecture for system or method of gift card redemption.

FIG. 2 is a system diagram which depicts an exemplary embodiment of hardware architecture for systems or methods of gift card redemption.

FIG. 3 is a flow chart which depicts an exemplary embodiment of a method of gift card redemption.

FIG. 4 is a schematic diagram of software interactions in an exemplary embodiment a system or method of gift card redemption.

FIG. 5A is an exemplary embodiment of a merchant's checkout page.

FIG. 5B is an exemplary embodiment of a modified checkout page.

### DETAILED DISCLOSURE

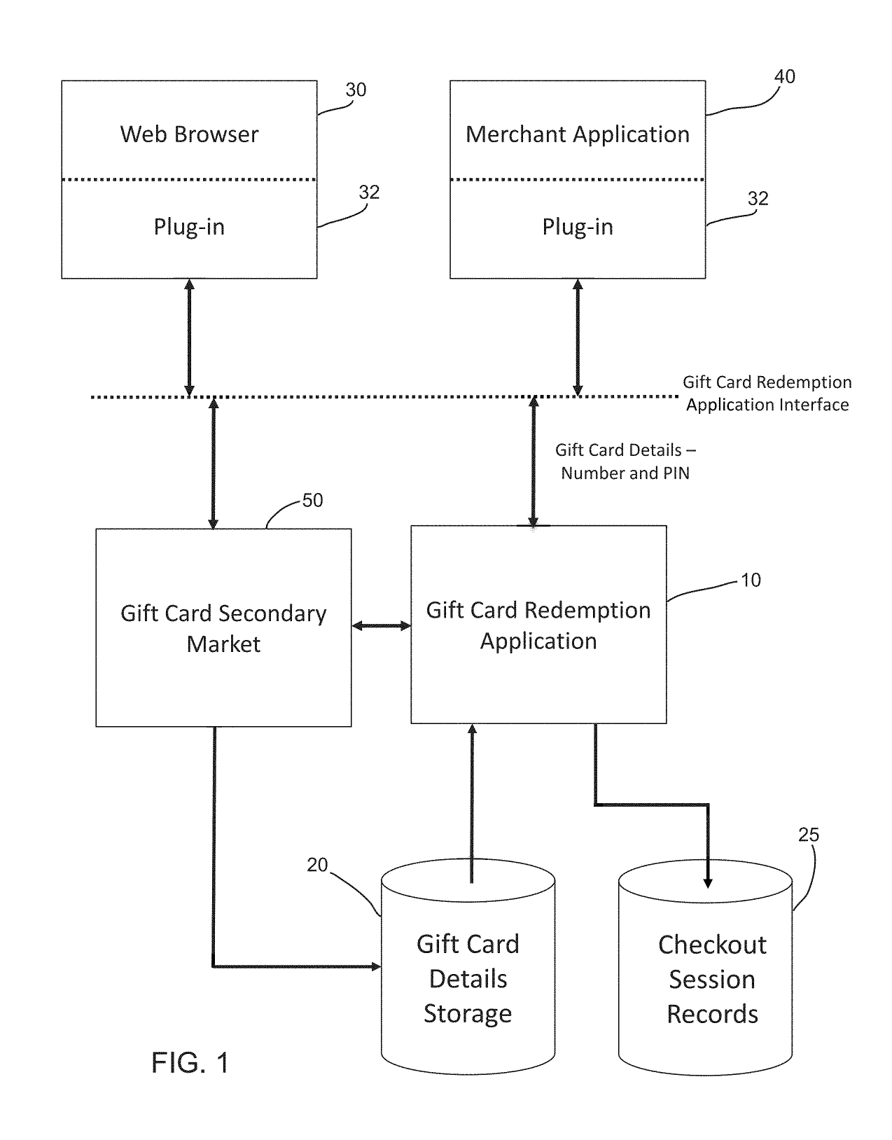

FIG. 1 depicts an exemplary embodiment of a software architecture for use in systems and methods of gift card redemption. As depicted in FIG. 1, a gift card redemption application 10 as described in further detail herein is able to access stored gift card details associated with the user of the application. The gift card redemption application 10 interacts with either or both of a web browser 30 accessing a merchant's webpage or a merchant application 40 provided by an internet enabled merchant to carry out a transaction as described herein to purchase a good or service from the merchant using a gift card purchased on a secondary market as identified in the gift card details storage 20. As used herein the term “merchant” is used to identify retailers or service providers which may be a party along with a purchaser to an on-line transaction. It will be recognized that various merchants may have one or both of a web based e-commerce platform as well as an application based e-commerce platform. As a non-limiting example, Amazon.com, Inc. is a merchant of goods and services through both a web based marketplace (e.g. available at www.amazon.com) as well as an application based marketplace (e.g. available through the downloadable Amazon App), at least a portion of which is stored and executed locally on an internet enabled computing device.

As will be described in further detail herein, in embodiments, the gift card redemption application 10 interacts with either or both of the web browser 30 and/or the merchant application 40 though a plug-in 32 to either the web browser 30 or the merchant application 40. The plug-in 32 is exemplarily computer code, which may be in the form of an executable routine or sub routine, e.g. implemented in Java Script, injected by the gift card redemption application 10 into the web browser 30 and/or merchant application 40.

FIG. 1 further includes a gift card secondary market 50 which may also be implemented in an application and/or in a web browser. It will be recognized that embodiments of the systems or methods as disclosed herein may be either incorporated into a gift card secondary market platform 50 or may be a stand alone application. In a still further embodiment, the gift card redemption application 10 may include the functionality to participate in a gift card secondary market.

Embodiments of the systems and methods as disclosed herein can incorporate actions in a gift card secondary market for example to process the transaction in which the gift card is purchased on the secondary market in a manner wherein the gift card details are stored at the gift card detail storage 20 without the buyer being provided with the actual details of the gift card as described herein. In other embodiments, this information may be obtained by other communication with the gift card secondary market platform 50.

In a further aspect of the methods and systems as disclosed herein, the gift card redemption application 10 interacts with merchant application programs and/or web browsers presenting the website of a merchant to modify or to extend the merchants interface provided in the application program or web browser to include aspects as disclosed herein of the systems and methods gift card redemption. The gift card redemption application 10 accesses the gift card details which have been separately stored apart from information that is readily accessible to the user. In this manner the gift card details can be transferred to the merchant website or application program in a secure and documented manner as will be disclosed in great detail herein.

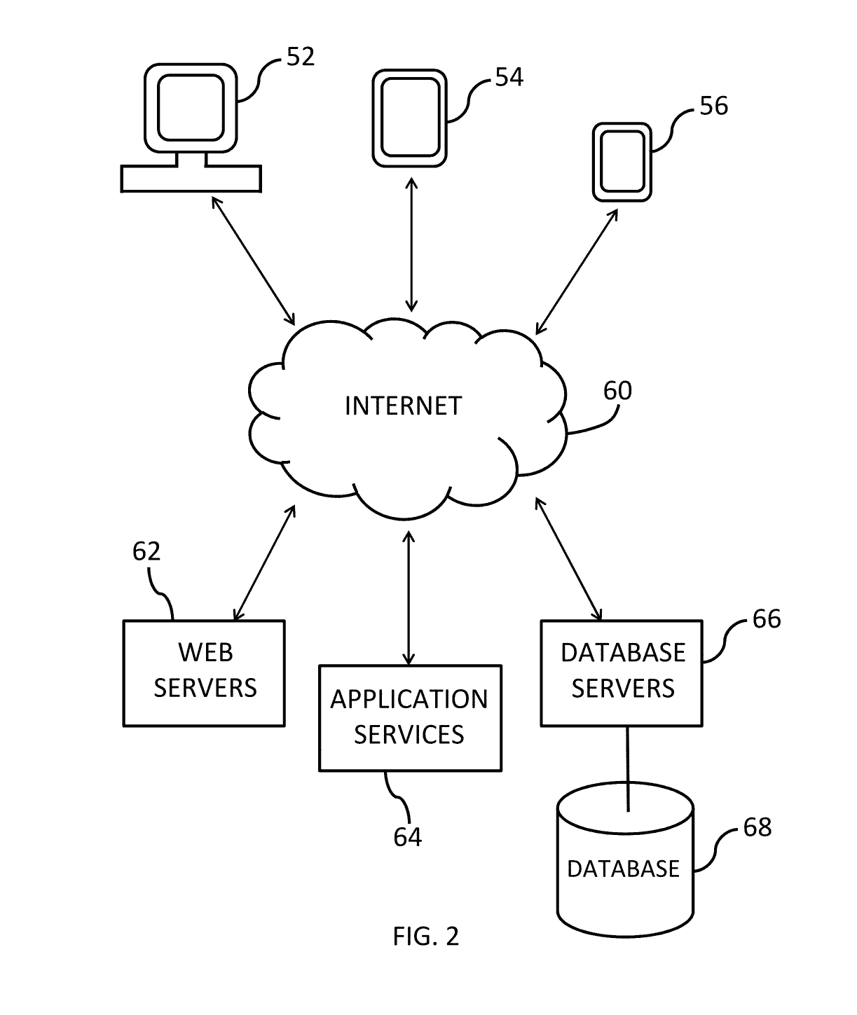

FIG. 2 depicts an exemplary embodiment of a hardware architecture which may be used in carrying out exemplary embodiments of the disclosed systems and methods. Embodiments may include a plurality of computing devices which may include, but are not limited to a desktop or a laptop computer 52, a tablet computer 54, or a smartphone 56. It will be recognized that these are merely exemplary and in no way limiting to the form of computing devices as may be used in exemplary embodiments as described herein. Each of the computing devices 52, 54, 56 are exemplarily communicatively connected to the internet 60. The internet 60, or another communication platform communicatively connects the computing devices 52, 54, 56 to a variety of computers organized as servers which may carry out various tasks within the systems and methods as described herein. These exemplarily include web servers 62, application servers 64, and database servers 66. Additionally, the database server 66 may be further connected to one or more databases 68 upon which information as used and described herein is stored and retrieved.

It will be recognized that in embodiments, the processing, storage, and receipt of information may be distributed across these components in carrying out various embodiments. Exemplarily, a web browser or merchant app includes computer code stored locally at the computing device which interacts across the internet with one or more of the web servers 62, application servers 64, and database servers 66. For example, a web browser stored locally at a computing device may communicate with one or more web servers 62 to access and present a website, for example a website of a merchant. In presenting such a website, data, computer code, and/or scripts that facilitate presentation and interaction (e.g. encryption or recording of a session) with said website may be stored locally at the computing device. Similarly, the computing device may have a merchant application stored locally at the computing device which can be executed by the processor of the computing device. Such execution of the application by the computing device may further cause communicative interaction with one or more application servers 64 to further enable functionality of the locally stored and executed application to carry out functions as described herein. Similarly, while web browsers and or applications being executed at a computing device may communicatively interact with data base servers 66 to access stored information as described herein, such that information may be managed at a storage location and in a consistent manner rather than relying upon locally stored versions of the information.

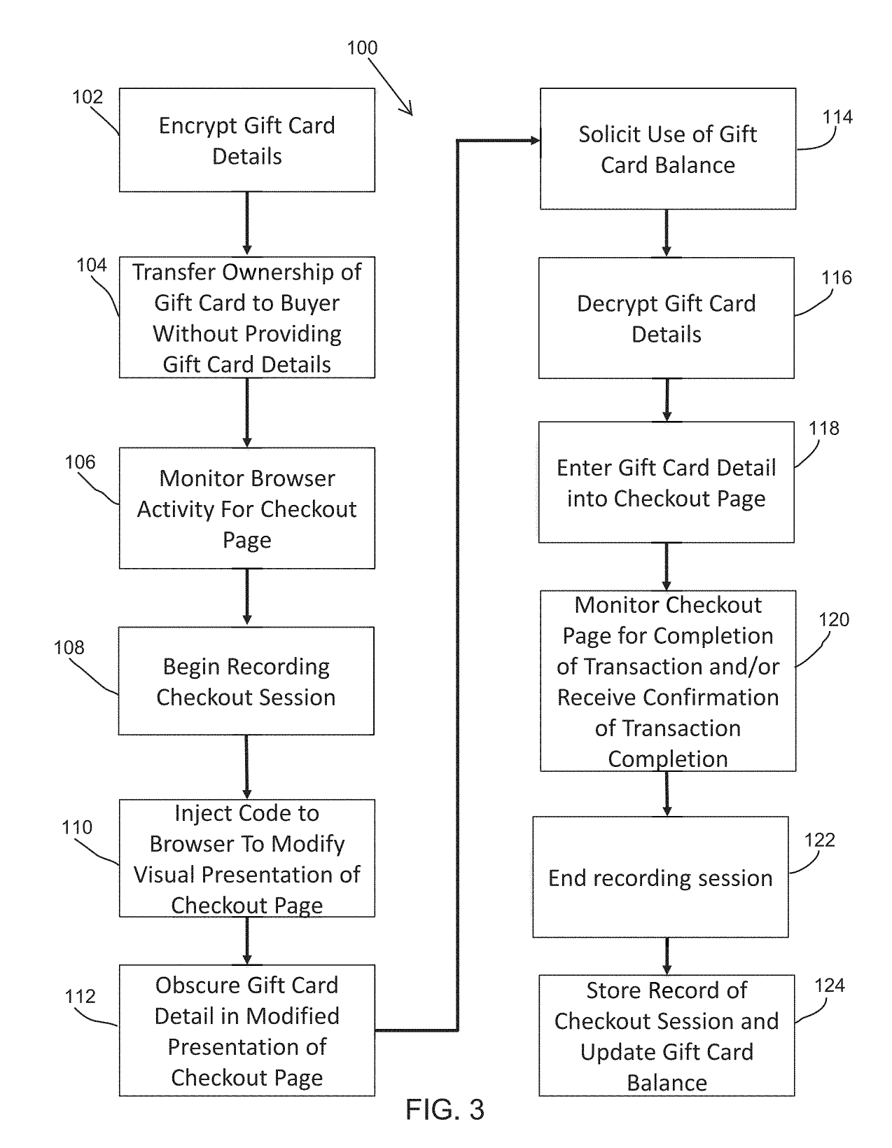

FIG. 3 is a flow chart that depicts an exemplary embodiment of a method 100 of gift card redemption.

The method 100 begins at 102 where gift card details are encrypted. Exemplarily, this occurs at the gift card secondary market platform, in an embodiment that is integrated with a gift card secondary market. Alternatively, this is provided outside of an embodiment of the method carried out by the gift card redemption application.

At 104, again exemplarily through a gift card secondary market ownership of a gift card is transferred from a seller of a gift card to a buyer of a gift card without the buyer being provided with the details of the gift card directly. For example, while the gift card secondary marketplace may identify the merchant and the amount on the gift card, identifiable information of the gift card, for example a serial number, bar code, and/or pin number may be held from disclosure to the buyer even after ownership of the gift card is transferred. Rather, the system maintains the gift card details in an encrypted manner, for example stored in the gift card details storage 20 identified in FIG. 1, which may be held in a remotely located database 68 as depicted in FIG. 2. Rather, the ownership of the purchased gift card is credited to the buyer within the gift card redemption application in an account therefor established by the buyer.

It will be recognized that the aforementioned actions may occur within a gift card secondary market platform which incorporates the gift card redemption application, or may be provided by another gift card secondary market. Therefore, in alternative embodiments, the gift card redemption application may operate as a stand alone application apart from a gift card secondary market or may operate in a manner integrated with a gift card secondary market platform.

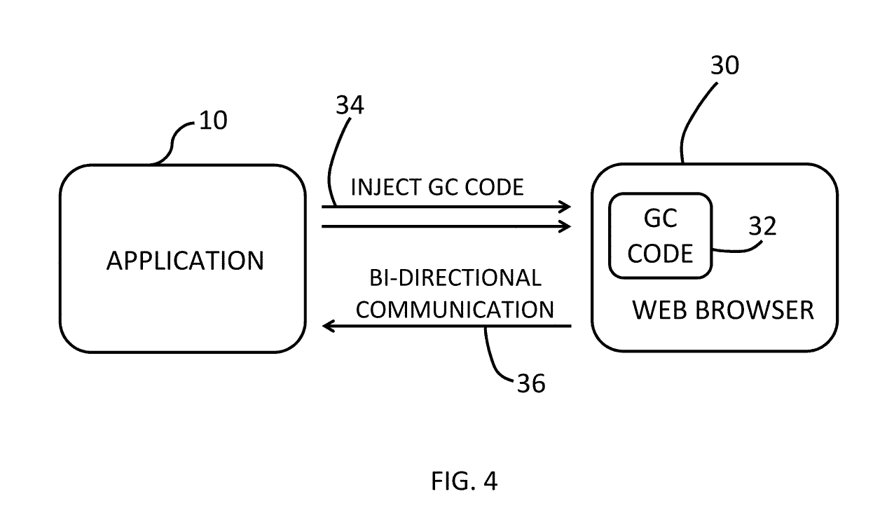

FIG. 4 is a schematic diagram that depicts an exemplary interaction between a gift card redemption application 10 and exemplarily a web browser 30 for example as in the context of the software architecture presented in FIG. 1. While FIG. 4 exemplarily depicts the interaction between an application 10 and a web browser 30, it will be recognized that a similar interaction may take place between a gift card redemption application 10 and a merchant application program 40 as depicted in FIG. 1.

The schematic diagram in FIG. 4 includes two environments which either may be implemented on the host servers and accessed by a computing device, or stored and executed locally from a computing device or a combination thereof. The gift card redemption application carries out many of the features as described in further detail herein with respect to FIG. 3 but also further carries out aspects of the disclosed system and method by injecting software in the exemplary form of a plug-in 32 and exemplarily identified as “GC code” into the web browser 30. Similarly this plug-in may be injected into merchant app residing on the computing device as well. The plug-ins cooperate with the browser/app to carry out the interactions and manipulations of the web browser/app to carry out the functions of the systems and methods as disclosed herein. The GC code 32a plug-in of injected code into the web browser environment and contains a utility library with a plurality of functions as needed to carry out functions disclosed herein, as well as functions which are specific to individual merchant websites. The GC code 32 enables communication between the gift card redemption application 10 and the web browser 30 as merchant websites are used to conduct transactions using one or more gift cards purchased on the secondary market.

Assuming that the GC code 32 has been injected 34 into the web browser 30 and bidirectional communication 36 is established between the gift card redemption application 10 and the web browser 30. Returning to the method 100 and FIG. 3, the method 100 further includes at 106 the web browser and/or application program activity is monitored for navigation to a merchant checkout page. As indicated above, the GC code plug-in establishes bidirectional communication between the web browser and the gift card redemption application. The bidirectional communication enables the gift card redemption application to monitor browser and or application activity for a checkout page at 106. In doing so, the gift card redemption application monitors the users' browsing to identify a particular type of action or navigation which has been defined as a checkout page. The code in the GC code plug-in may include code which is specific to a particular merchant or website and identifies the specific details of a particular merchant checkout page, thus enhancing the ability to identify when that page is loading. Additionally, the GC code plug-in includes further code to identify general features of a merchant's checkout page which may be used to identify checkout pages of merchant's not already specifically identified in the GC code plug-in. If the user navigates away from the merchant's checkout page then GC code may be reinjected because script memory is reset when a new page loads and the GC code plug-in continues to monitor the browser activity for when the checkout page is loaded.

When the user navigates to the merchant's checkout page the GC code plug-in detects this navigation and communicates the event to the gift card redemption application. Upon being notified of this navigation at 108 the gift card redemption application begins recording the checkout session. Recording in the checkout session identifies and documents key information about the online transactions which is about to be initiated. Exemplarily, information which is stored may include the URL of the checkout page, the html code of the checkout page, customer events related to brand (e.g. current cart total, list of items in cart), and user actions (e.g. scrolling, clicks, typing). Additionally, because the gift card redemption application is typically operating on a mobile computing device and the gift card redemption application processes the recording of the checkout session of the gift card redemption application can add additional information for example geolocation and/or a user's mobile phone number associated with the transaction.

As explained above with respect to FIGS. 1 and 4, the 110 the gift card redemption application injects the GC code plug-in into the web browser. The GC code plug-in is exemplarily a computer code sub route or a java script that modifies an existing web browser or app. As will be described in further detail herein, the GC code plugin modifies the visual presentation of the checkout page in the web browser at 112.

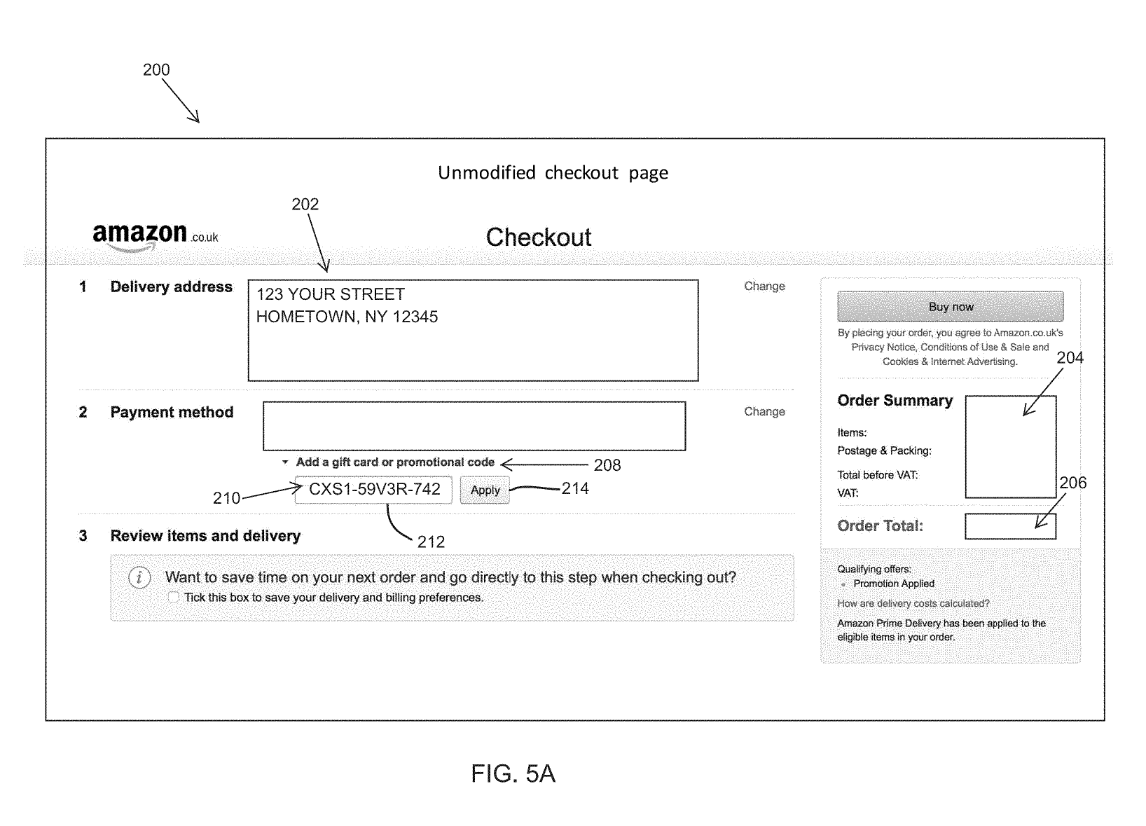

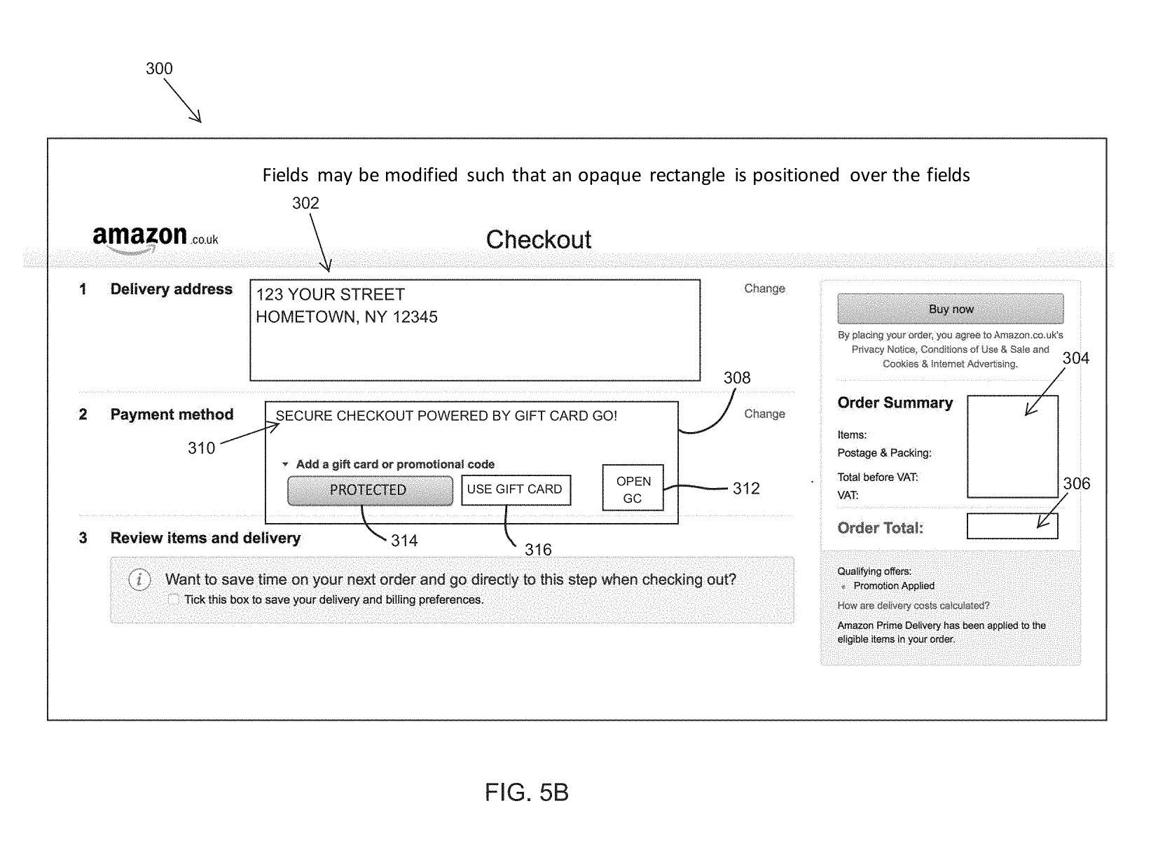

FIG. 5A depicts an exemplary embodiment of a merchant's checkout page 200. The merchant's checkout page 200 exemplarily provides a delivery address 202, a summary of the order 204, and an order total 206. In the “payment method” section of the checkout page 200, the user is prompted to select a payment method at 208 and prompted to enter gift card detail information 210 into a field 212 configured to receive such information. The gift card detail information 210 is exemplarily a serial number or other account number associated with the gift card. After this information has been entered by the user, the user can select (e.g. by a mouse click or finger tap, although other input methods are recognized and my be used) the “Apply” button 214 to apply the gift card balance to the amount of the order total 206.

FIG. 5B depicts an exemplary embodiment of a modified checkout page 300 in accordance with an exemplary embodiment of systems and methods as disclosed herein. A comparison of the exemplary merchant's checkout page 200 of FIG. 5A to the exemplary modified checkout page 300 of FIG. 5B notes that some information and/or portions of he checkout pages 200, 300 ma exemplarily remain unchanged. For example, the delivery address 302 summary of the order 204, and the order total 306 may remain the same from the merchant's checkout page 200. This information is personal and known to the user and is needed by the user to accurately place the user's desired order.

However, the GC code plug-in 32 modifies the properties of the gift card related areas and fields from the merchant's checkout page 200 so that the user is not able to see the gift card details and further adds and or modifies buttons associated with applying a gift card (or gift cards) to a purchase e.g. to interface with the gift card redemption application). As depicted in FIG. 5B, embodiments of the modified checkout page 300 includes modifications to the area of the checkout page related to payment and/or use of a gift card. In the exemplary embodiment of the modified checkout page 300, the checkout page is modified including with a border or boundary 308 which helps identify to the user the area of the checkout page which has been modified. It will be recognized that in alternative embodiments, no such boundary 308 may be used. Although in embodiments the modified checkout page 300 may include a title or statement 310 proving an identification of the use of the gift card redemption application. The checkout page may further be modified to include at least one additional button 312 which adds functionality to the checkout page that was not previously provided therein. For example, button 312 may be selected by the user to open the gift card redemption application, for example for the user to check the balances of one or more gift cards or to purchase additional gift cards through a gift card secondary market as explained above with respect to FIG. 1.

As will be described in further detail herein, embodiments of the systems and methods modify the checkout page to obscure the gift card detail information as it is entered into the appropriate field in the merchant's checkout page. For example, the entire field (212 in FIG. 5A) is obscured by a graphic 314. However, it will be recognized that other modifications to the checkout page may be used to carry out this purpose as are described in further detail herein. Additionally, the checkout page is modified with a button 316 which prompts the user to use a gift card as explained herein. This interaction differs from the user interaction with the merchant's checkout page as the merchant's checkout page prompts the user to apply a gift card, the information for which has been entered into the respective field by the user. Rather, in embodiments, the user selects the button 316 and the systems and methods as described in further detail herein operate to complete the transaction using at least a portion of a balance of at least one gift card.

In exemplarily embodiments, the gift card field 212 of the checkout page 200 is modified to obscure the gift card detail information in the merchant's checkout page. For example, if the input type of the field (in a web browser) is modified to “password” this results in any text entered in this modified field being masked (e.g. with asterisks or circles). In another embodiment the visual representation of the field may further be modified by changing a property of the fields to “display none” and any information entered into these fields may be invisible or replaced with random characters. In a still further exemplary embodiment, the visual representation of the gift card fields may be modified such that an opaque rectangle (e.g. graphic 314) is positioned over the field which may further obscure and or block visibility of the gift card details.

Next, after visual presentation of the checkout page is modified, the user may be solicited to use a gift card balance at 114. This use may be solicited for example, as mentioned above, by the addition or modification of a button 316 on the modified checkout page 300 to prompt a user to “use gift card,” and particularly a gift card purchased on a secondary market and/or managed by the gift card redemption application. After the user selects to use a gift card balance as managed by the gift card redemption application, the gift card details are decrypted from the remote gift card detail storage at 116 and the gift card details are entered into the checkout page at 118. In doing so, the decrypted gift card details are sent to the gift card redemption application and entered into the merchant's original webpage by the GC code plug-in, however, through the modifications to the visual presentation of the checkout page in the web browser by the GC code plug-in, the actual gift card details remain obscured from the user.

In order to apply the gift card to the transaction, the gift card redemption application securely transmits the gift card data to the merchant through the merchant's web page. This may be carried out in a variety of ways. In a first example, user actions are emulated in the user interface via code in the GC code plug-in. These emulated actions interact with the merchant's user interface to input the gift card details. In another embodiment, the gift card details may be populated directly into the underlying API of the merchant's original web page. Additionally, the transmission of data from the retailer's web page may be replicated and the gift card details directly inserted into the transmission. In a still further embodiment, the properties of user interface buttons may be modified such that when they are clicked by a user a function is executed to transfer the gift card data as determined by the application.

As previously described, the GC code plug-in is able to monitor browser and or app activity to identify web pages and or actions by the user. At 120 the GC code plug-in monitors the browser and/or application, particularly the checkout page presented therein for a completion of the transaction. As noted above, this may be carried put by using data or code that particularly identifies a completion of a transaction with in a specific merchant's web page or application or defines general characteristics or features which may help to identify a completion of a transaction with another third party merchant. For example, the GC code plug-in may recognize the process and format of how a transaction is completed through a particular merchant's website. For example, this may include the particular manners and process steps taken to complete a transaction, including but not limited to entering of credit card details, actuation of a complete purchase button, followed by a payment approval, and presentation of a purchase confirmation notification to the user. Upon identification of the transaction completion, the application is notified that the transaction is complete.

Upon receiving this notification, the application ends the recording session at 122 and securely stores a record of the checkout session and updates the gift card balance at 124. The record of the checkout session is securely sent and stored at a database of checkout session records 25 as record of the transaction. The checkout session record includes the information as identified above which provides for example, but not limited to details of the merchant, the user, the computing device used, the location, and/or amount in the transaction. It will be recognized that in embodiments, for example for privacy or security purposes, the checkout session record may be exemplarily stripped of sensitive data, for example credit card numbers used to complete the transaction. This checkout session record can be later used in the event of query related to the transaction in the event of possible fraud. The gift card redemption application also updates the records of the user's gift cards purchased on the secondary market in the gift card details storage to reflect any remaining gift card balances available after the transaction has been processed.

Embodiments of the systems and methods as described herein provide increased security against fraud by either sellers or buyers of gift cards on the secondary market by keeping the actual details of the gift card obscured from the buyer. In this manner if an amount of a gift card is not the purported amount, the inquiry may focus on the seller as the buyer does not have access to the actual details of the gift card but for use through the gift card redemption application. Similarly, in the event of a charge back claim by the buyer, a record of the checkout session including relevant detail of the transaction are recorded and may be reviewed to evaluate the buyer's claim.

In the above description, certain terms have been used for brevity, clarity, and understanding. No unnecessary limitations are to be inferred therefrom beyond the requirement of the prior art because such terms are used for descriptive purposes and are intended to be broadly construed. The different systems and method steps described herein may be used alone or in combination with other systems and methods. It is to be expected that various equivalents, alternatives and modifications are possible within the scope of the appended claims.

The functional block diagrams, operational sequences, and flow diagrams provided in the figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology can alternatively be represented as a series of interrelated states or events, such as in a state diagram. Moreover, not all acts illustrated in a methodology may be required for a novel implementation.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method of gift card redemption, the method comprising:
modifying a third-party application operating on a computing device to establish bi-directional communication between the third-party application and a gift card redemption application operating on the computing device;
monitoring the activity of the third-party application for navigation to a checkout page;
initiating recording of a transaction at the checkout page;
injecting code to the third party application to modify the visual presentation of the checkout page;
upon a user request of payment through the gift card redemption application, accessing encrypted gift card details with the gift card redemption application;
decrypting the gift card details and entering the gift card details into the third party application;
monitoring the third party application for completion of the transaction; and
completing recording of the transaction and storing a record of the transaction.

2. The method of claim 1, wherein the third party application is a web browser.

3. The method of claim 1, wherein the third party application is an app.

4. The method of claim 1, wherein the visual presentation of the checkout page is modified to obscure gift card details.

5. The method of claim 1, further comprising modifying the visual presentation of the checkout page to visually present buttons to solicit payment through the gift card redemption application.

6. A system for gift card redemption through a computing device, the system comprising:
means for monitoring a third party application operating on the computing device, identifying navigation to a checkout page with the third party application, and identifying completion of a transaction within the third party application;
means for recording the transaction and storing a record of the transaction; and
means for modifying the visual presentation of the checkout page within the third party application to obscure gift card details when entered into the third party application to complete the transaction.
